(19) United States
(12) Patent Application Publication
(10) Pub. No.: US 2015/0364950 A1
(43) Pub. Date: Dec. 17, 2015

(54) AUXILIARY EXCITATION DEVICE OF A GENERATOR AND METHOD FOR CONTROLLING POWER EXCITATION OF THE SAME

(71) Applicant: Kutai Electronics Industry Co., Ltd., Kaohsiung City (TW)

(72) Inventor: Wen-Feng Lu, Kaohsiung City (TW)

(21) Appl. No.: 14/302,799

(22) Filed: Jun. 12, 2014

(51) Int. Cl. H02J 11/00; H02P 9/10

(52) U.S. Cl. CPC H02J 11/00; H02P 9/10

(57) ABSTRACT

An auxiliary excitation device is applied to a generator with a self-excited automatic voltage regulator (AVR). The auxiliary excitation device is installed between a battery and the AVR and constantly monitors the status of output voltage of the generator. When the output voltage of the generator instantaneously drops to a preset variation level, the auxiliary excitation device will convert a DC voltage from the battery into an AC voltage and boost the AC voltage to an auxiliary AC power. The auxiliary power is outputted to the AVR for the AVR to output excitation power to the generator, thereby providing additional excitation power to the generator and raising the output power of the generator.

### BACKGROUND OF THE INVENTION

1. Field of the Invention

This invention is an auxiliary excitation device of a generator and a method for controlling power excitation of the auxiliary excitation device, and more particularly to, an auxiliary excitation device capable of transforming DC (Direct Current) power of a battery into an AC (Alternating Current) auxiliary excitation power for a generator.

2. Description of the Related Art

When in operation, a generator needs to use an excitation system to create a magnetic field for the generator to generate AC power, and the energy for creating the magnetic field is known as an excitation power.

Based on supply means of excitation sources, excitation systems can be classified into self-excitation, separate excitation types, and other types of excitation. An automatic voltage regulator (AVR) serves to control the excitation systems and determine whether output voltage of the generator is stable.

With reference to FIG. 7, a conventional self-excitation system supplies a portion of power from the generator output to the AVR such that excitation source generated by the AVR is returned to the generator for use.

However, the disadvantage of this type of systems is that output voltage of the generator drops when the load suddenly increases (such as activation of a large motor). Under this circumstance, the power of the AVR also drops steeply and causes excitation power outputted from the AVR dropping to an extremely low level that leads to failure in power generation of the generator.

With reference to FIG. 8, separate excitation systems acquire power for magnetic excitation from an excitation source other than the generator, for example a permanent magnet generator (PMG). This type of excitation systems can overcome the disadvantages of the foregoing self-excitation system and will not suffer from loss of excitation source when heavier load is applied and can thus continuously supply the excitation source to the AVR. However, the drawbacks of the separate excitation systems reside in bulky size, heavy weight, and high cost.

### SUMMARY OF THE INVENTION

An objective of the present invention is to provide an auxiliary excitation device of a generator and a method for controlling power excitation, which utilize electrical power from a battery to create an excitation source, while having the benefits of compact size, low cost and convenient installation at the same time.

To achieve the foregoing objective, the auxiliary excitation device is applied to a generator with an automatic voltage regulator (AVR) and a battery and is connected between the battery and the AVR. The auxiliary excitation device has a processor, a battery voltage input circuit, a generator output monitoring circuit, a setting circuit, an auxiliary power generating circuit and an auxiliary power measuring circuit.

The processor has a control program built therein for determining whether to output auxiliary power.

The battery voltage input circuit is connected to the processor, receives and measuring a DC (Direct Current) voltage of the battery, converts the DC voltage into an operating power, and provides the measured DC voltage to the processor.

The generator output monitoring circuit is connected to the processor, monitors a voltage value and a frequency of an output voltage of the generator, and provides the voltage value and the frequency of the output voltage to the processor.

The setting circuit is connected to the processor and serving to set a default voltage drop percentage.

The auxiliary power generating circuit is connected to the processor and the battery voltage input circuit, is controlled by the processor to convert the DC voltage of the battery into the auxiliary power in the form of AC (Alternating Current) power, and outputs the auxiliary power to the AVR.

The auxiliary power measuring circuit is connected to the processor, measures a voltage value of the auxiliary power, and provides the voltage value of the auxiliary power to the processor.

The processor determines to output the auxiliary power when an inequality dV≧Vavg×p is met, where Vavg is a moving average of the output voltage of the generator, Vi is an instantaneous output voltage value of the generator, dV is a difference between Vavg and Vi, and p is a preset voltage drop percentage.

To achieve the foregoing objective, the method for controlling power excitation is performed by an auxiliary excitation device. The auxiliary excitation device is applied to a generator with an automatic voltage regulator (AVR) and a battery. The method has steps of:

monitoring operation status of a generator, wherein voltage of output power from the generator is detected and recorded to obtain a moving average of values of the voltage of the output power of the generator and an instantaneous value of the voltage of the output power of the generator;

determining if the generator is in operation;

determining if the auxiliary excitation device is outputting an auxiliary power when the generator is in operation;

determining if the auxiliary power has entered a standby mode for output when the auxiliary power is not outputted;

determining if the output voltage of the generator has an instantaneous drop according to an inequality dV≧Vavg×p when the auxiliary power has entered a standby mode for output; where

Vavg is the moving average of the values of the voltage of the output power of the generator;

Vi is the instantaneous output voltage value of the generator;

dV is a difference between Vavg and Vi; and

p is a preset voltage drop percentage;

outputting the auxiliary power to the AVR when the voltage of the output power from the generator suddenly drops, wherein the auxiliary power is an AC (Alternating Current) power converted from a DC (Direct Current) power of the battery; and

determining if a condition of stopping output of the auxiliary power to the AVR have been established and, and stopping output of the auxiliary power when the condition has been established.

The present invention compared with devices or methods pertinent to self-excited or separately excited type of excitation systems has at least the following advantages and efficacy:

Compared with permanent magnet generators, the present invention has reduced volume, light weight, and low manufacturing cost, and possesses the same effectiveness of a permanent magnet generator without the result of overload affecting stable output of auxiliary power.

During installation, the auxiliary excitation device only needs to be electrically connected to the battery and thus simplifies the installation job.

The auxiliary excitation device only outputs the auxiliary power when the voltage outputted from the generator significantly drops. When the generator normally operates, the auxiliary excitation device is maintained at a standby mode as requiring very small power. As almost no power of the battery is consumed, the battery can still be kept at its original capacity. Even though the output voltage of the generator is dropping, instead of using the auxiliary excitation device for supplying the auxiliary power, the AVR can be used to supply the self-excited power as long as the output voltage variation is within a load range that the generator can afford.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a generator and an auxiliary excitation device applied thereto in accordance with the present invention;

FIG. 2 is a functional block diagram of the auxiliary excitation device in FIG. 1;

FIGS. 3A to 3R are circuit diagrams of the auxiliary excitation device in FIG. 1;

FIGS. 4A and 4B are parts of a flow diagram of a method for controlling excitation of the auxiliary excitation device in FIG. 1;

FIG. 5 is a waveform diagram showing if an output voltage of a generator in FIG. 1 has entered a steady state;

FIG. 6 is a waveform diagram showing timing when an excitation source of the auxiliary excitation device in FIG. 1 is outputted and stopped.

FIG. 7 is a schematic view of a conventional self-excitation system; and

FIG. 8 is a schematic view of a conventional separate excitation system.

### DETAILED DESCRIPTION OF THE INVENTION

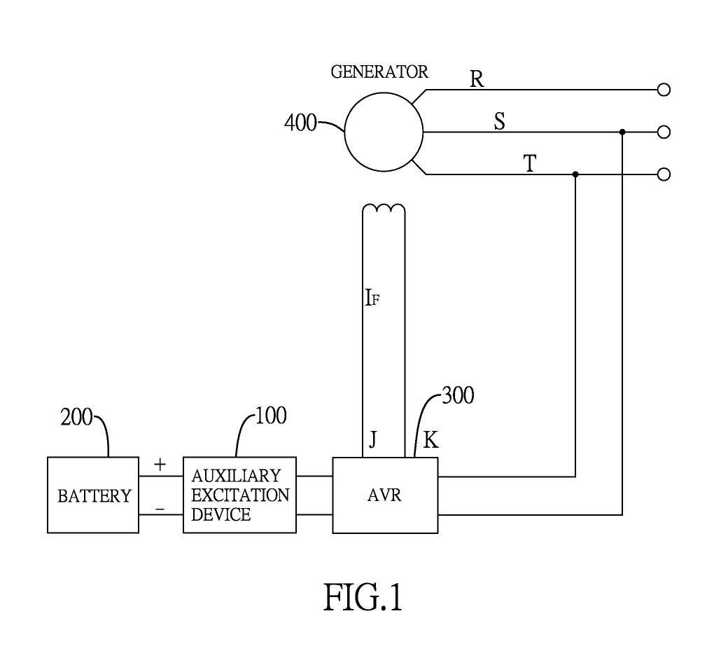

With reference to FIG. 1, an auxiliary excitation device 100 in accordance with the present invention is applied to a generator with a battery 200 and an automatic voltage regulator (AVR) 300 and is connected between the battery 200 and the AVR 300. The auxiliary excitation device 100 makes use of DC power of the battery 200. When a voltage of output power of the generator 400 drops to a preset level, the auxiliary excitation device 100 may output an auxiliary power V_{AUX} to the AVR 300. The battery 200 may be an additional one or an existing battery in the generator 400.

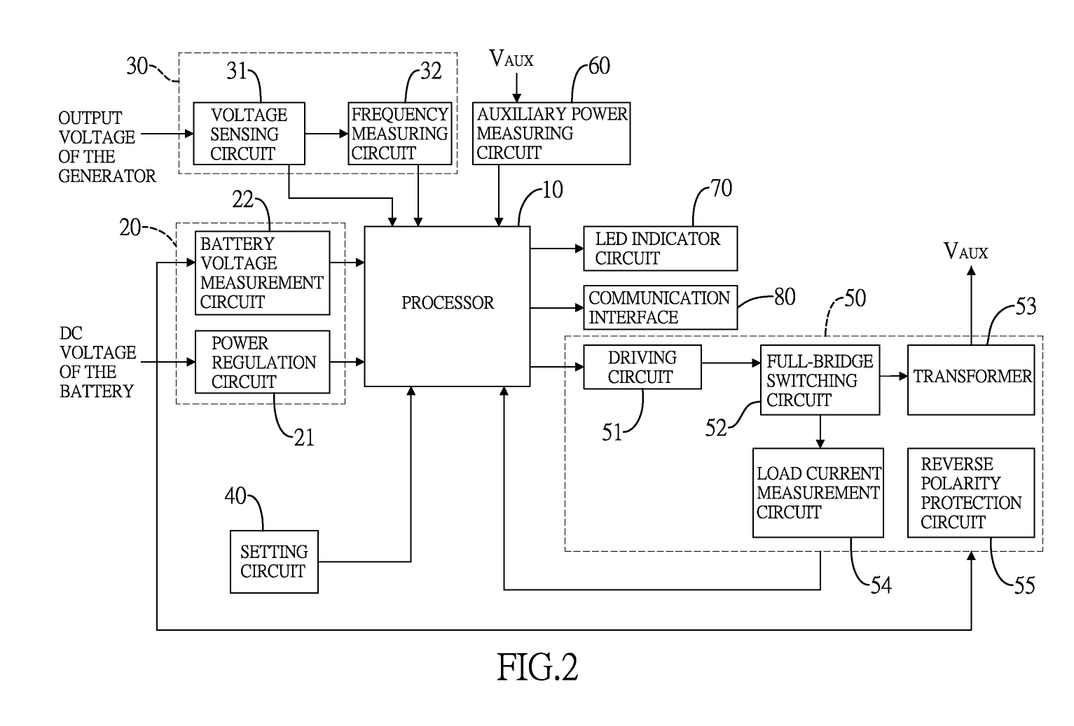

With reference to FIG. 2, the auxiliary excitation device 100 has a processor 10, a battery voltage input circuit 20, a generator output monitoring circuit 30, a setting circuit 40, an auxiliary power generating circuit 50, and an auxiliary power measuring circuit 60.

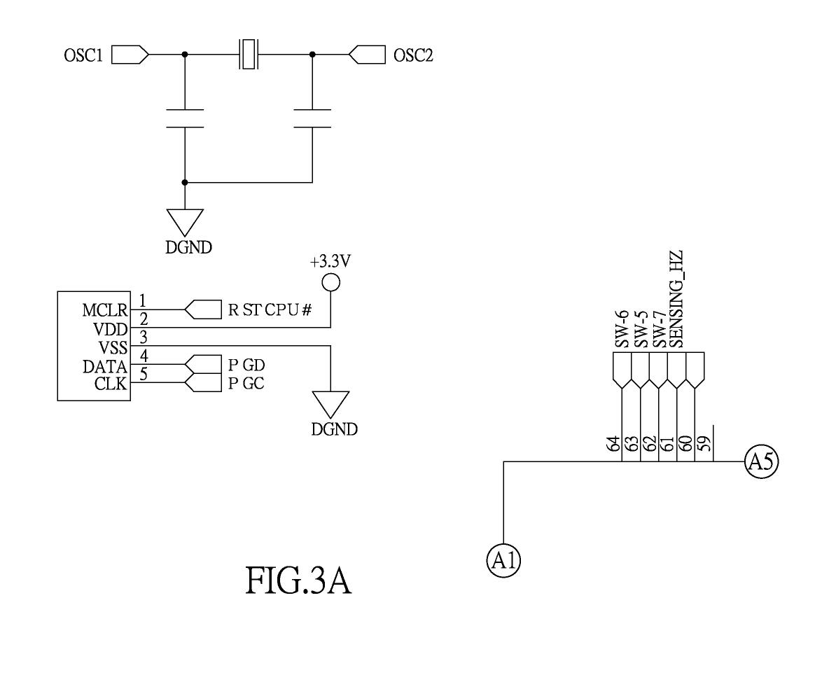

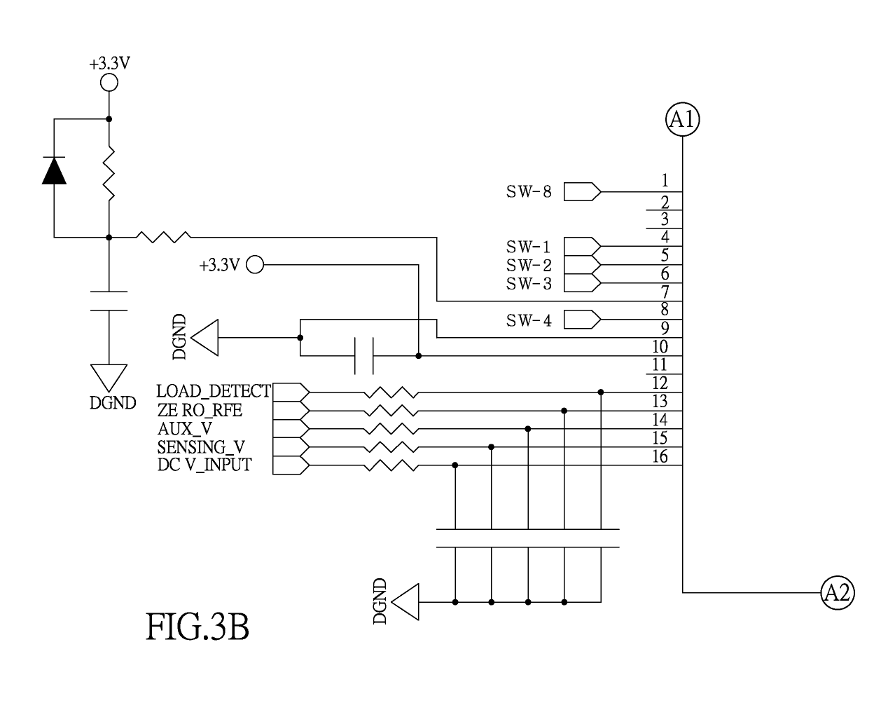

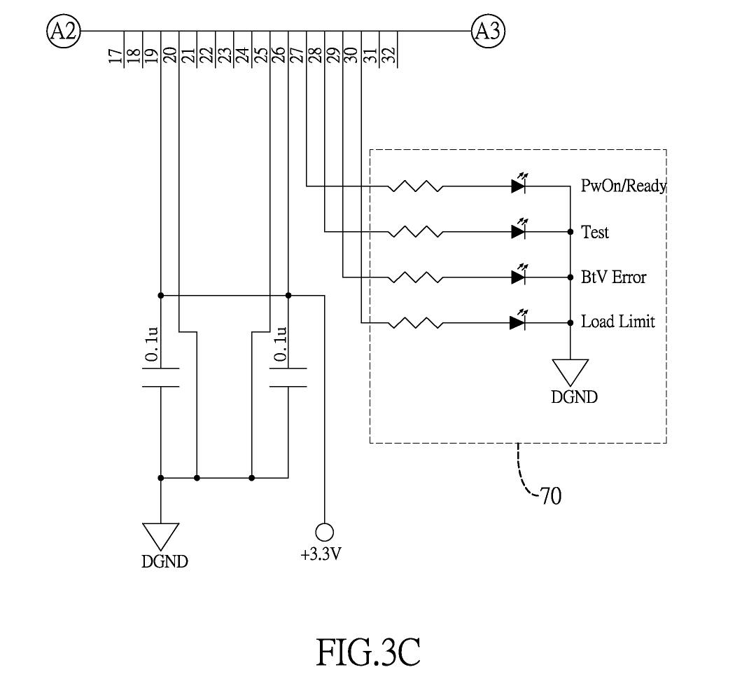

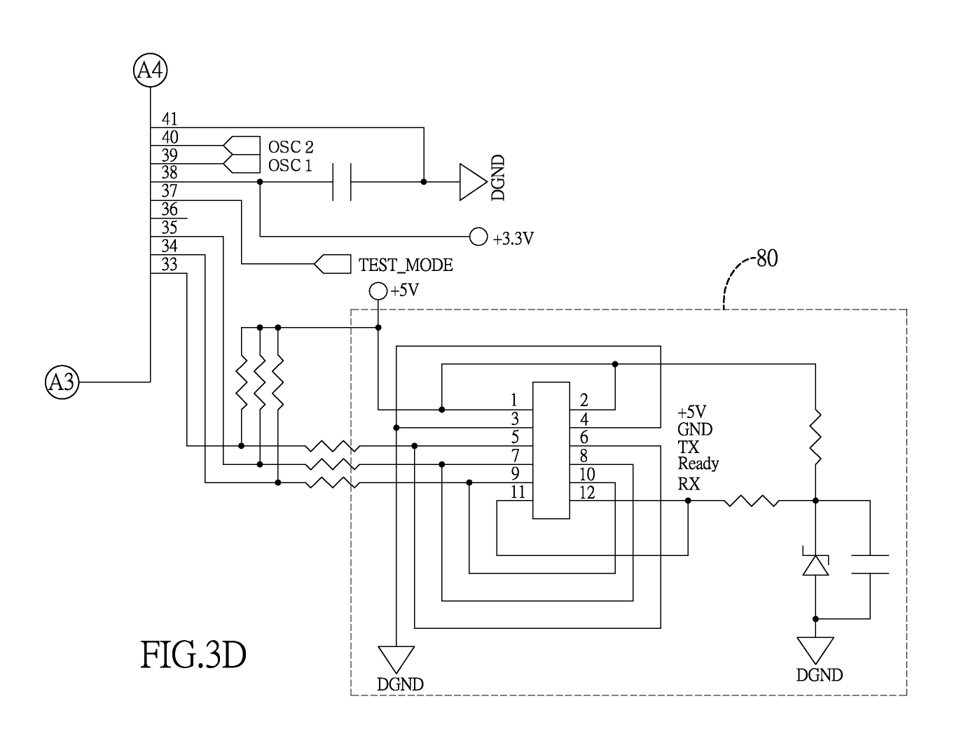

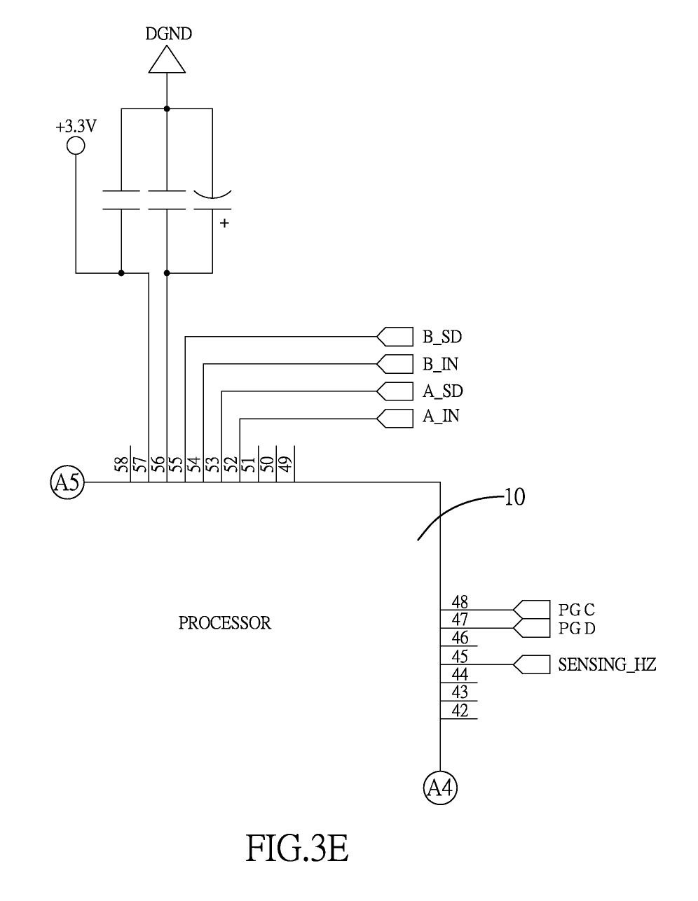

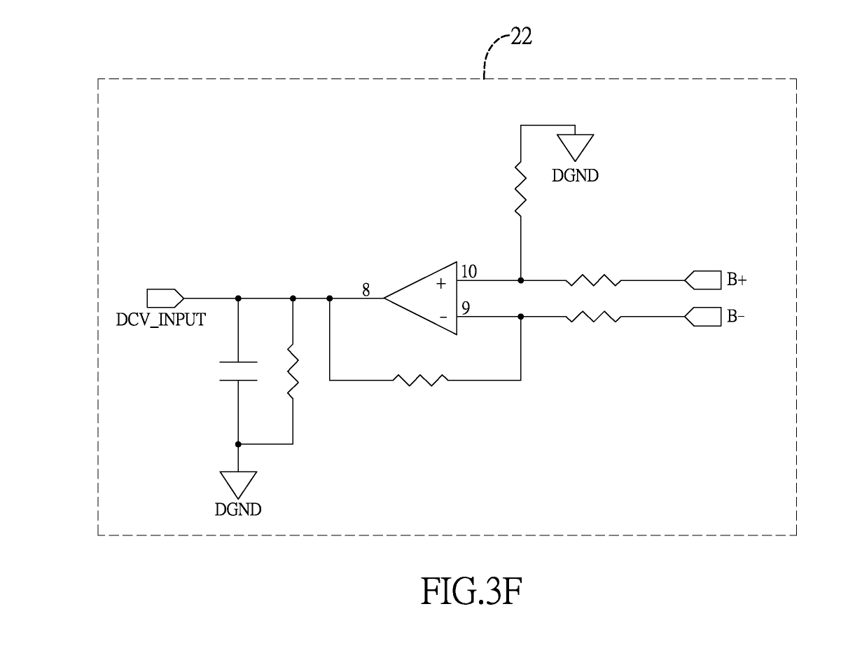

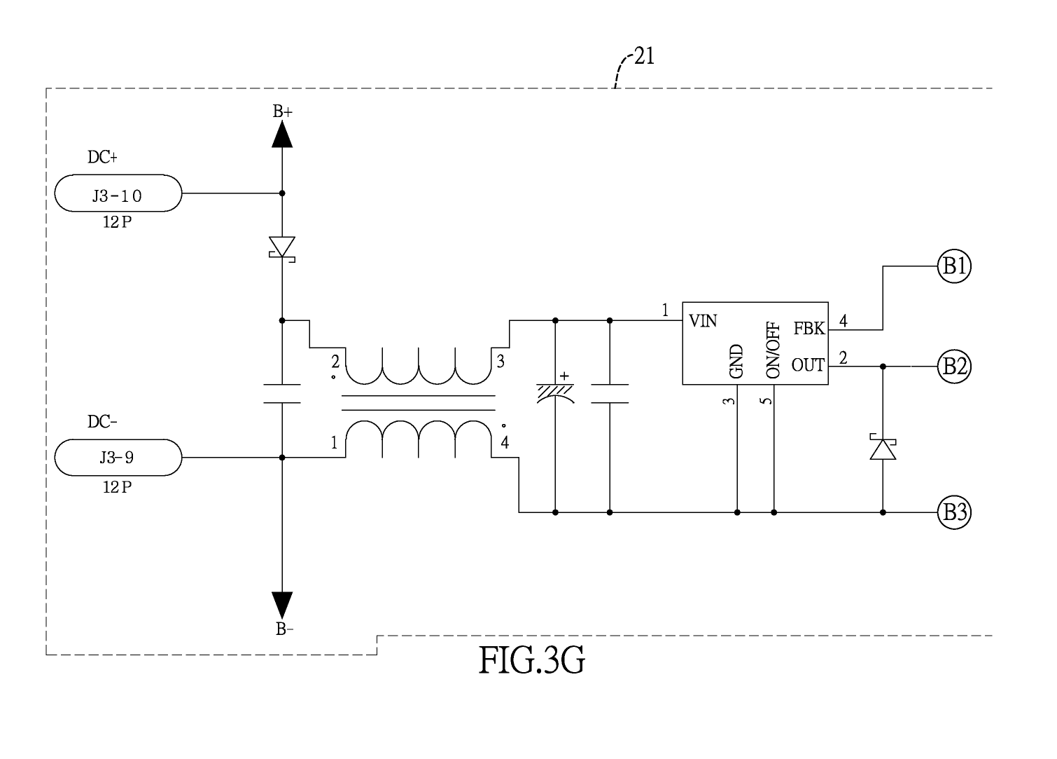

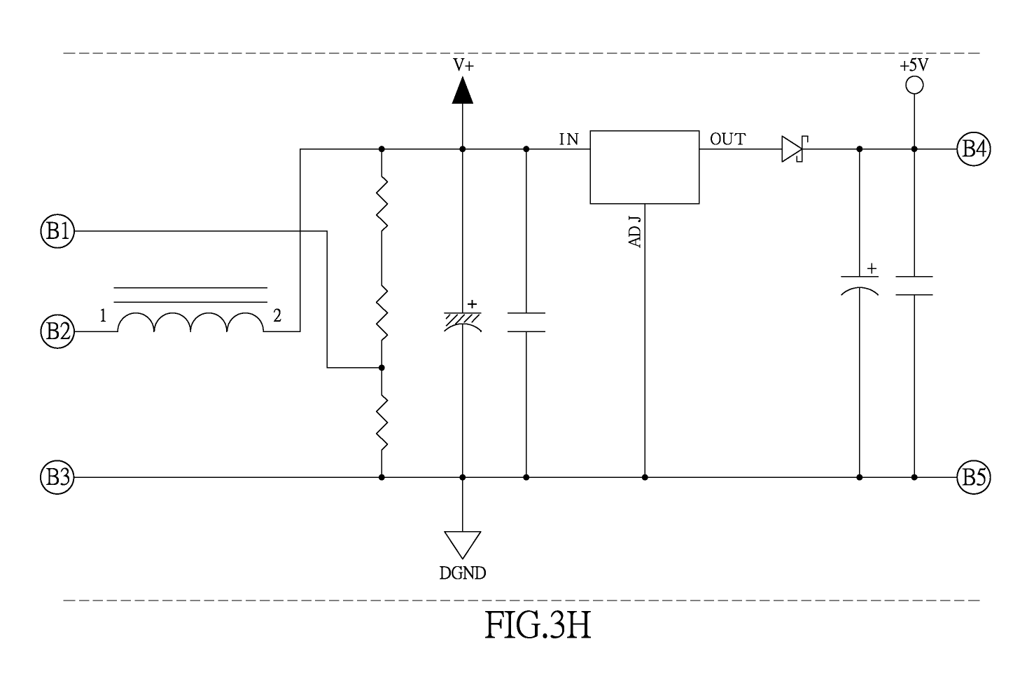

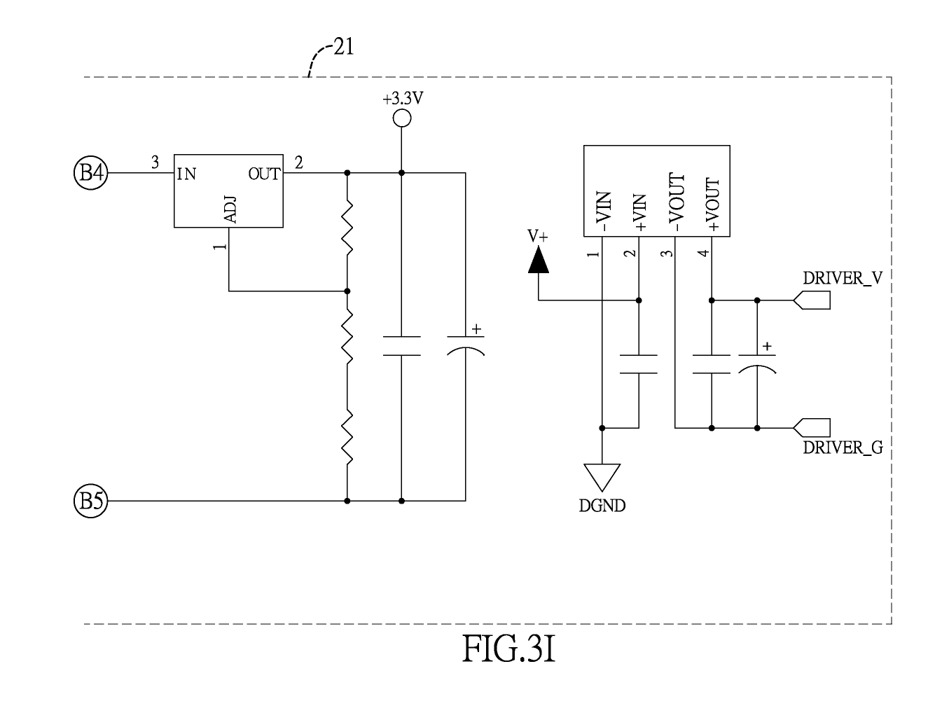

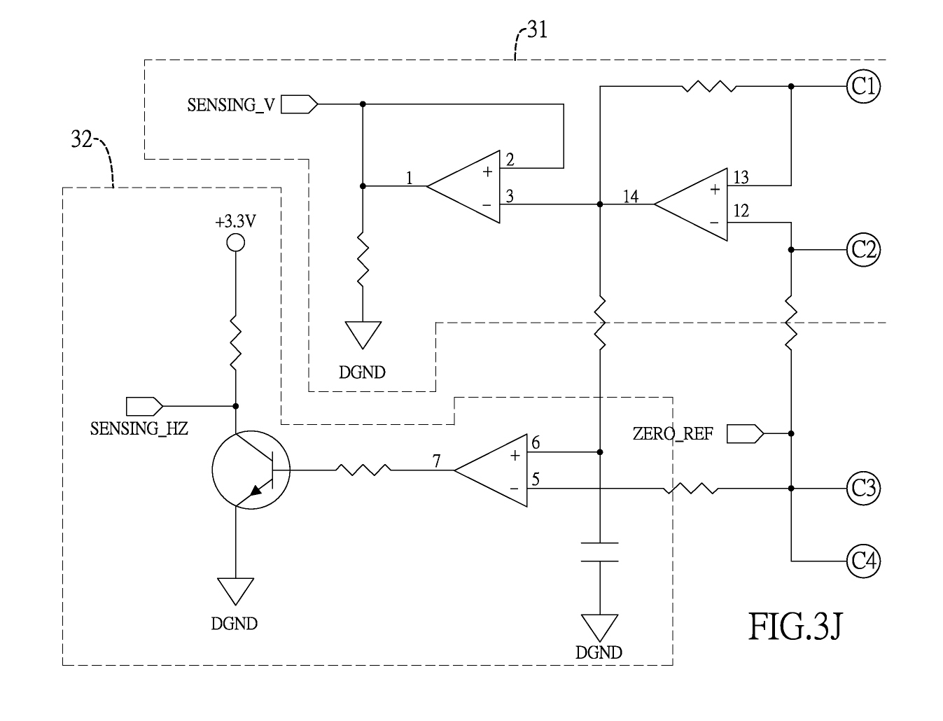

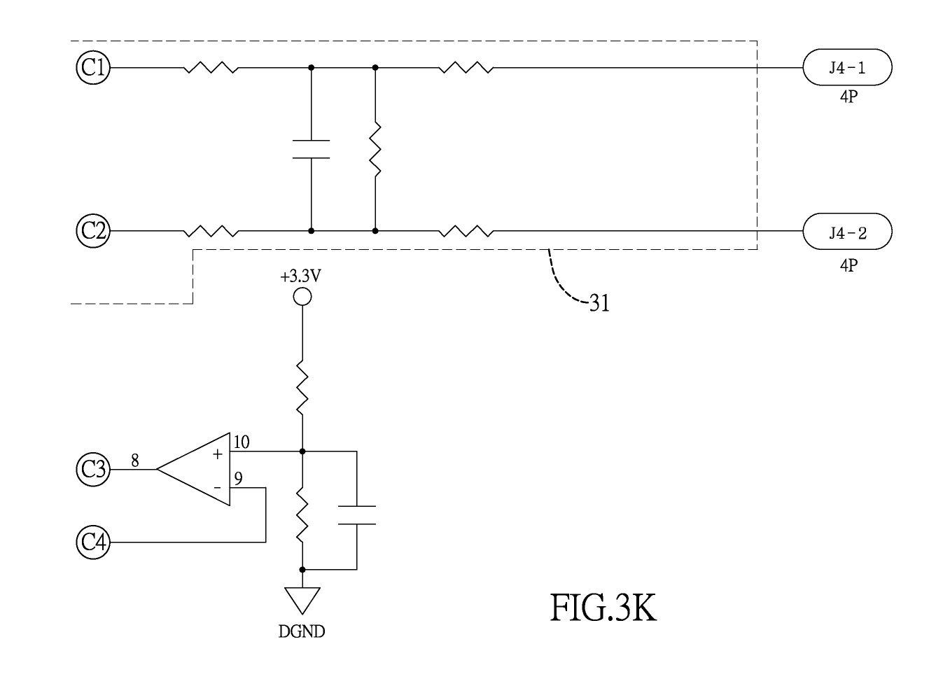

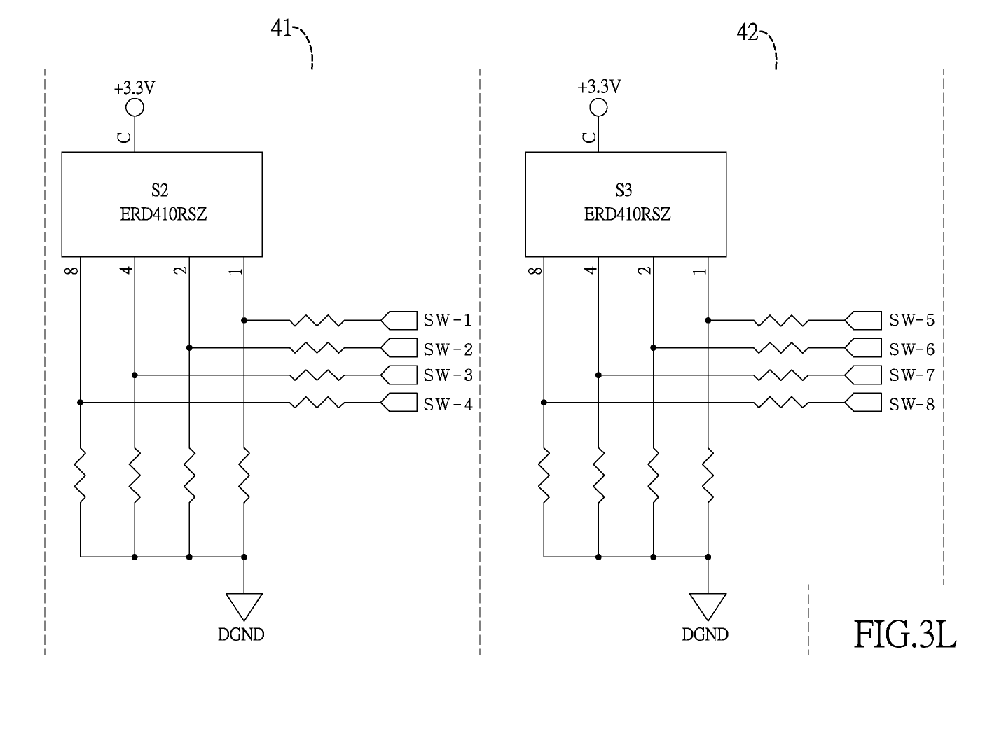

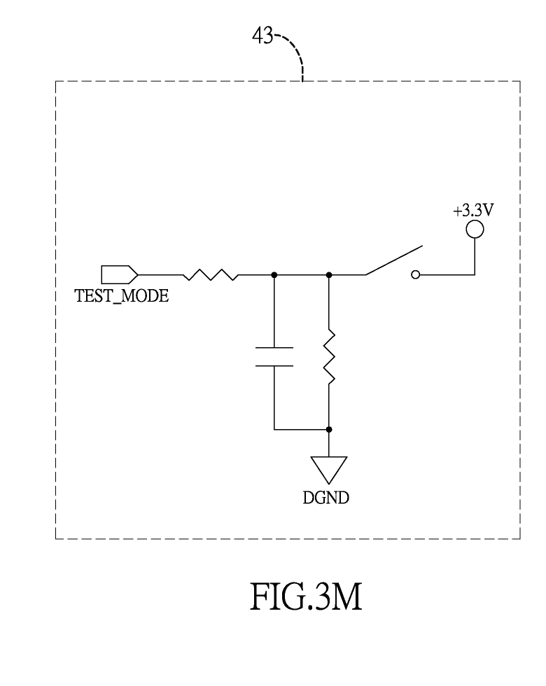

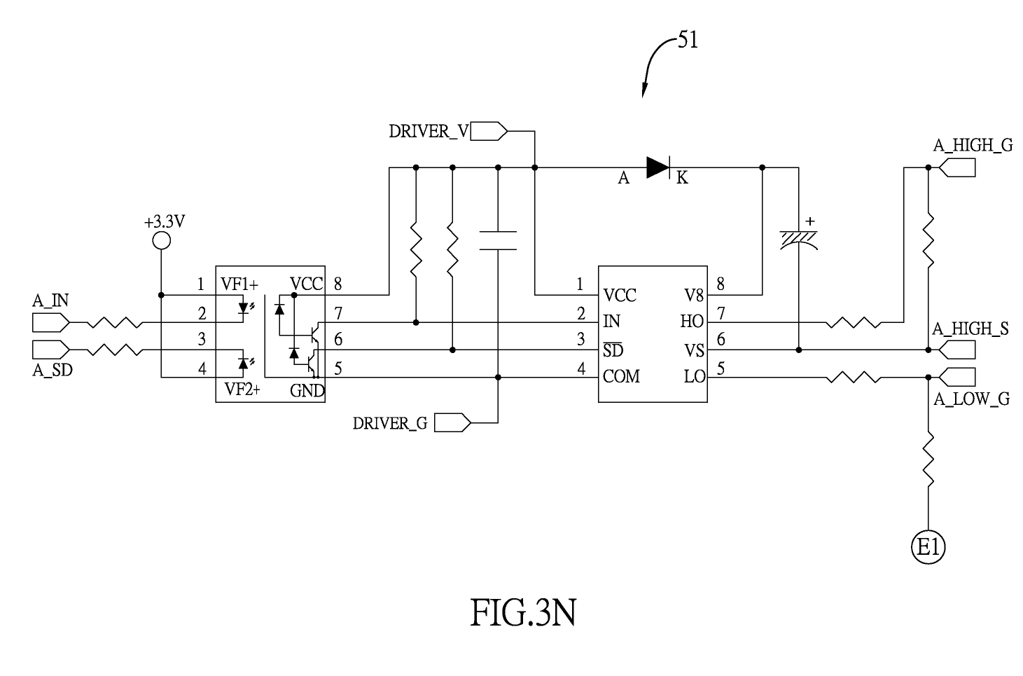

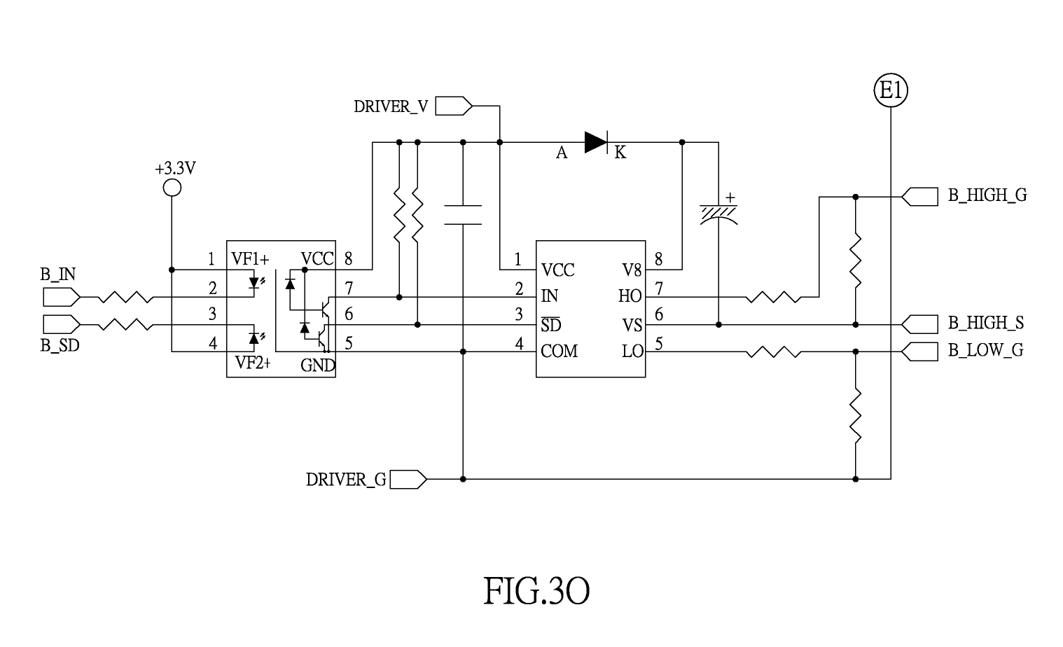

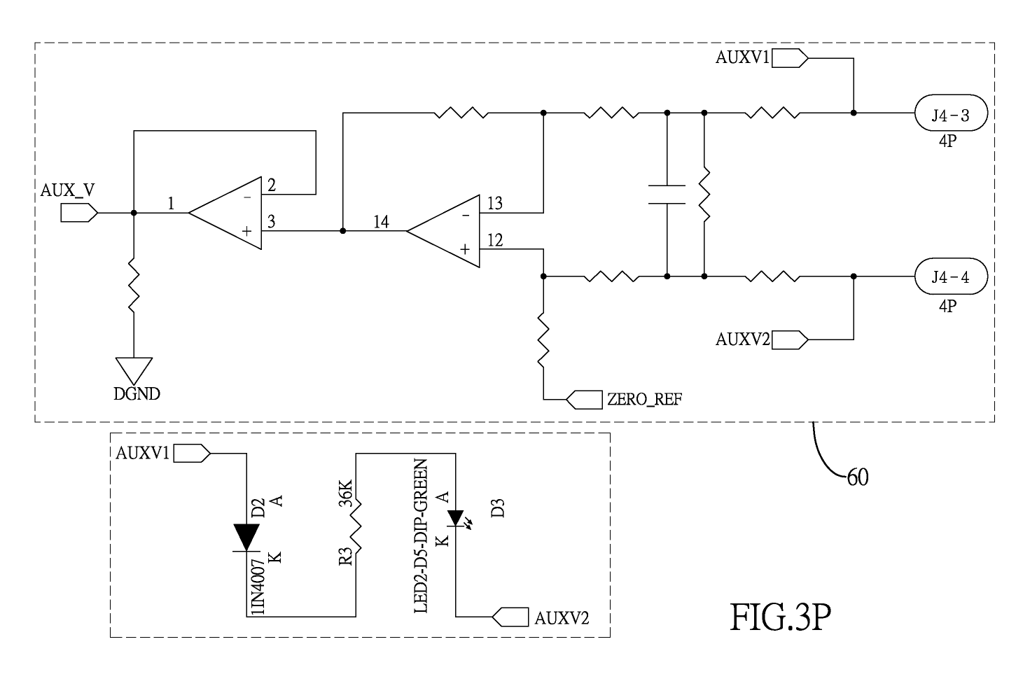

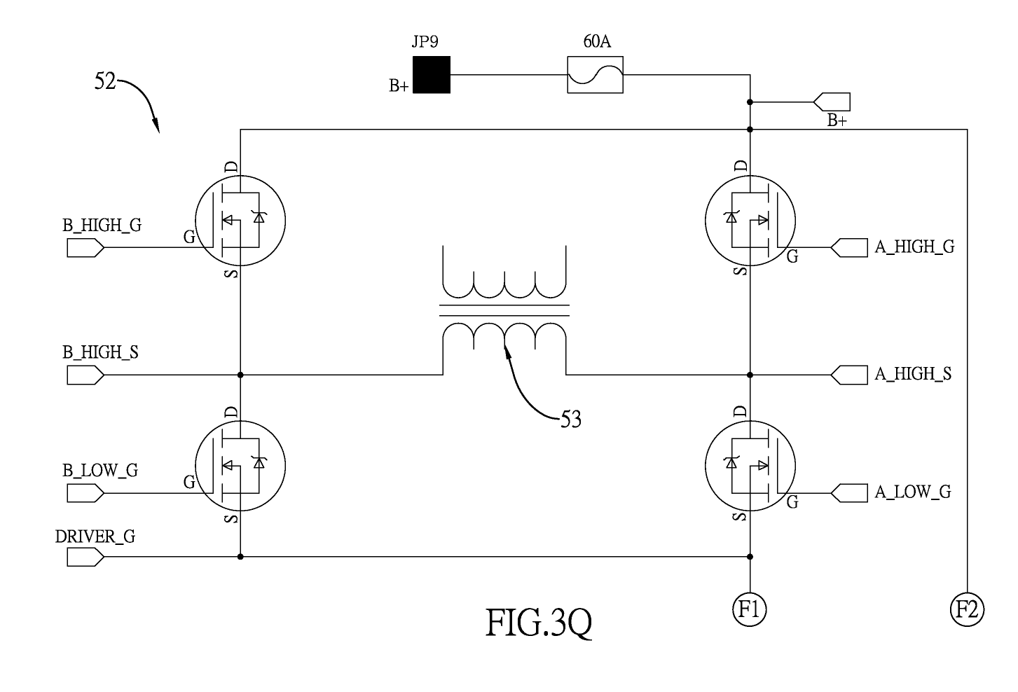

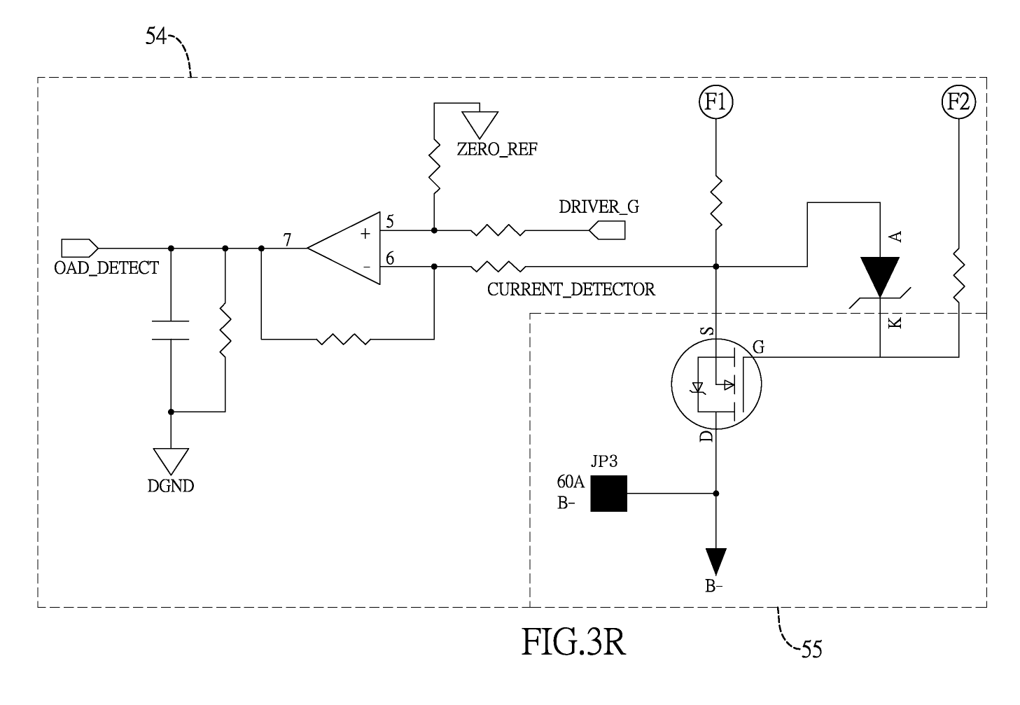

With reference to FIGS. 3A to 3E, the processor 10 has a control program built therein for controlling all other circuits, carrying out computation based on various input information received and controlling the auxiliary power V_{AUX}.

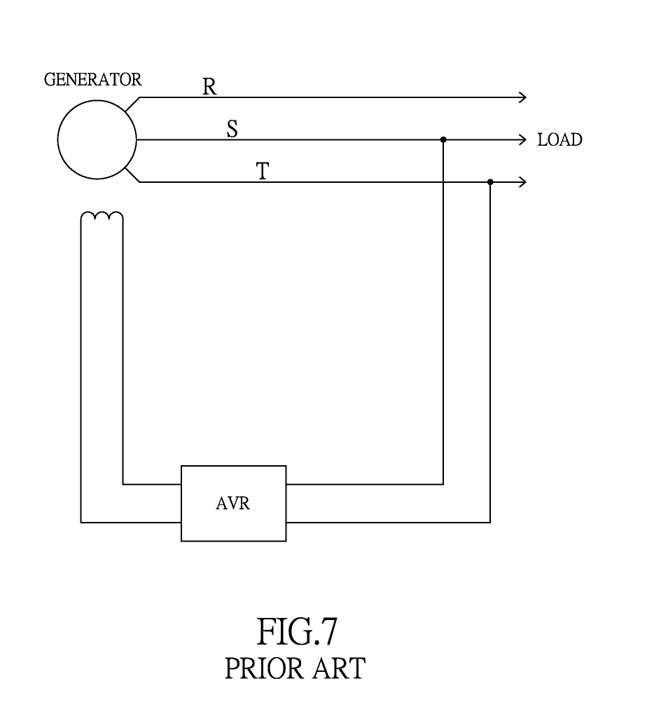

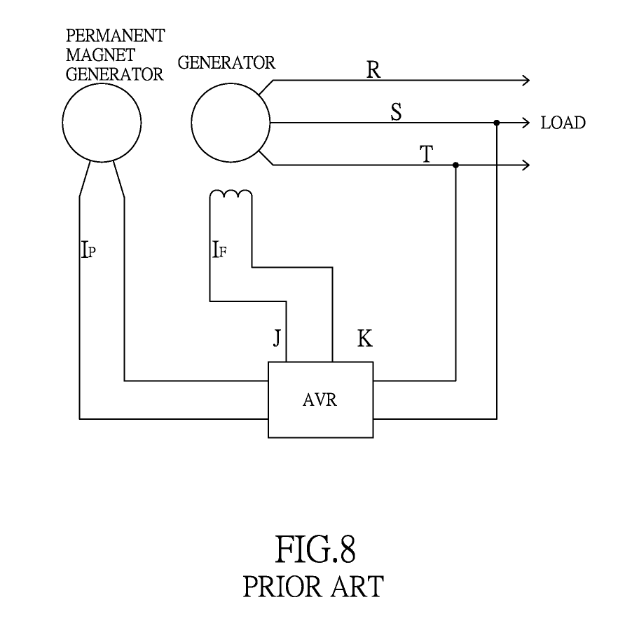

With further reference to FIGS. 3F to 31, the battery voltage input circuit 20 receives the DC (Direct Current) power from the battery, converts the DC power to an operating power required by the auxiliary excitation device 100, and measures a DC voltage value of the battery and sends the DC voltage value to the processor 10 at the same time.

In the present embodiment, the battery voltage input circuit 20 includes a power regulation circuit 21 and a battery voltage measurement circuit 22. The power regulation circuit 21 converts the DC power of the battery 200 into the operating power at a voltage level, for example +3.3 V or +5 V, to supply the auxiliary excitation device 100. The battery voltage measurement circuit 22 measures the DC voltage value of the battery 200 and sends the DC voltage value of the battery to the processor 10.

With reference to FIGS. 3J to 3K, the generator output monitoring circuit 30 monitors the voltage and a frequency of the output power of the generator 400, and provides the detected values of the voltage and frequency of the output power of the generator 400 to the processor 10.

In the present embodiment, the generator output monitoring circuit 30 includes a voltage sensing circuit 31 and a frequency measuring circuit 32. The voltage sensing circuit 31 receives and measures the voltage of the output power of the generator 400 and transmits a value of the measured voltage to the processor 10. The frequency measuring circuit 32 measures the frequency of the output power of the generator 400 and transmits a value of the frequency to the processor 10.

With reference to FIGS. 3L to 3M, the setting circuit 40 is provided for users to configure operation parameters or tests required by the users. The operation parameters may include a preset voltage drop percentage (p), an overtime threshold, and the like. The setting circuit 40 has a voltage drop level setting circuit 41, an auxiliary power output overtime setting circuit 42 and a manual test circuit 43.

The voltage drop level setting circuit 41 serves to set the preset voltage drop percentage (p), which is taken as a criterion for determining whether to output the auxiliary power V_{AUX}. The auxiliary power output overtime setting circuit 42 serves to set the overtime threshold, which is defined as a longest continuous output time of the auxiliary power V_{AUX}. When the overtime threshold is expired, voltage of the auxiliary power V_{AUX} gradually drops until output of the auxiliary power V_{AUX} is completely stopped. The manual test circuit 43 is provided for users to manually perform tests on their own.

With reference to FIGS. 3N to 3R, the auxiliary power generating circuit 50 is controlled by the processor 10 to output the auxiliary power V_{AUX}, and has a driving circuit 51, a full-bridge switching circuit 52, a transformer 53, a load current measurement circuit 54 and a reverse polarity protection circuit 55. The driving circuit 51 shown in FIGS. 3N to 30 is connected between the processor 10 and the full-bridge switching circuit 52 and generates multiple driving signals for controlling the full-bridge switching circuit 52 according to control signals of the processor 10.

With reference to FIGS. 3P to 3R, the full-bridge switching circuit 52 is connected to the driving circuit 51 and the battery voltage input circuit 20, and contains multiple switching transistors. These switching transistors are alternately turned on or off according to the driving signals generated by the driving circuit 51 to convert the DC power of the battery 200 into an AC (Alternating Current) power. The transformer 53 is connected to an output terminal of the full-bridge switching circuit 52 to boost the AC power for generating the auxiliary power V_{AUX} that is supplied to the AVR 300. The load current measuring circuit 54 detects current passing through the full-bridge switching circuit 52, converts a value of the current into a current signal, and transmits the current signal back to the processor 10. The reverse polarity protection circuit 55 is connected to the battery voltage input circuit 20, and serves to prevent users from reversely connecting polarities of the battery 200 to the auxiliary excitation device 100. When the polarities of the battery 200 are reversed, the reverse polarity protection circuit 55 immediately interrupts connection between the battery 200 from the auxiliary excitation device 100 to prevent damage to the auxiliary excitation device 100.

With further reference to FIGS. 3P to 3R, the auxiliary power measuring circuit 60 serves to measure voltage of the auxiliary power V_{AUX}, return a value of the voltage of the auxiliary power V_{AUX} to the processor 10 for the processor 10 to monitor voltage variation of the auxiliary power V_{AUX}.

In addition, the processor 10 may further include a light-emitting diode (LED) indicator circuit 70 and a communication Interface 80. The LED indicator circuit 70 serves to display operation status of the of the auxiliary excitation device in accordance with invention, and may include, but are not limited to, a low battery voltage indicator, a current overload indicator, a test mode indicator, a power/standby indicator.

The communication interface 80 is provided for the auxiliary excitation device 100 to be connected to an external device so that the external device can conduct function tests, calibration and firmware update via the communication interface 80 to determine if circuits of the auxiliary excitation device 100 work properly.

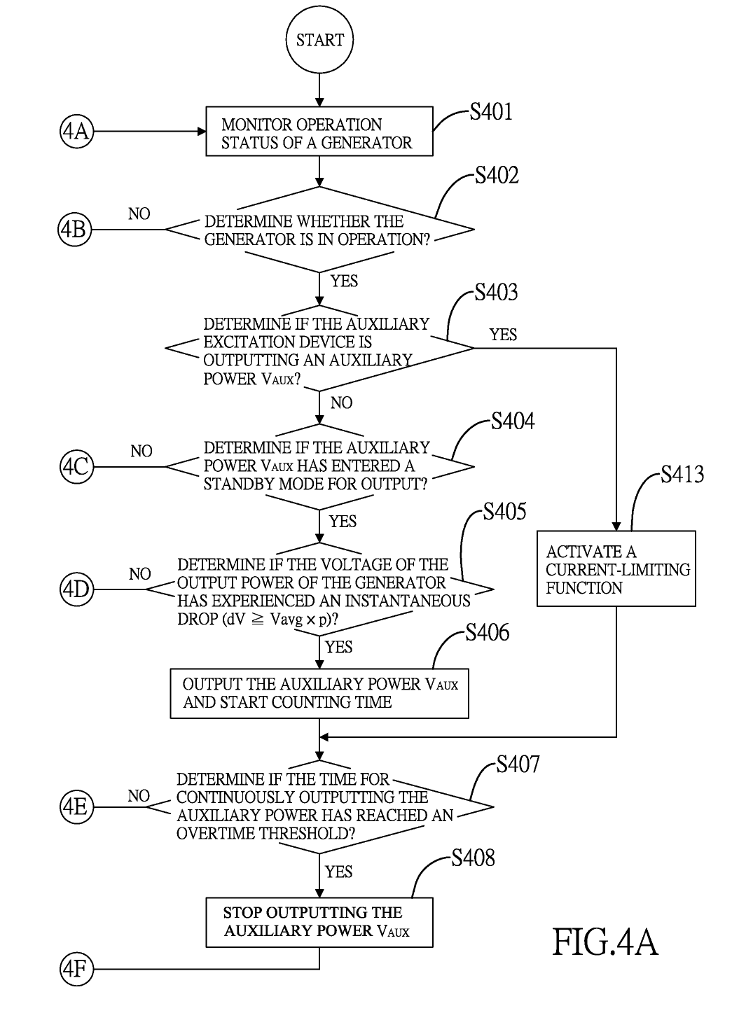

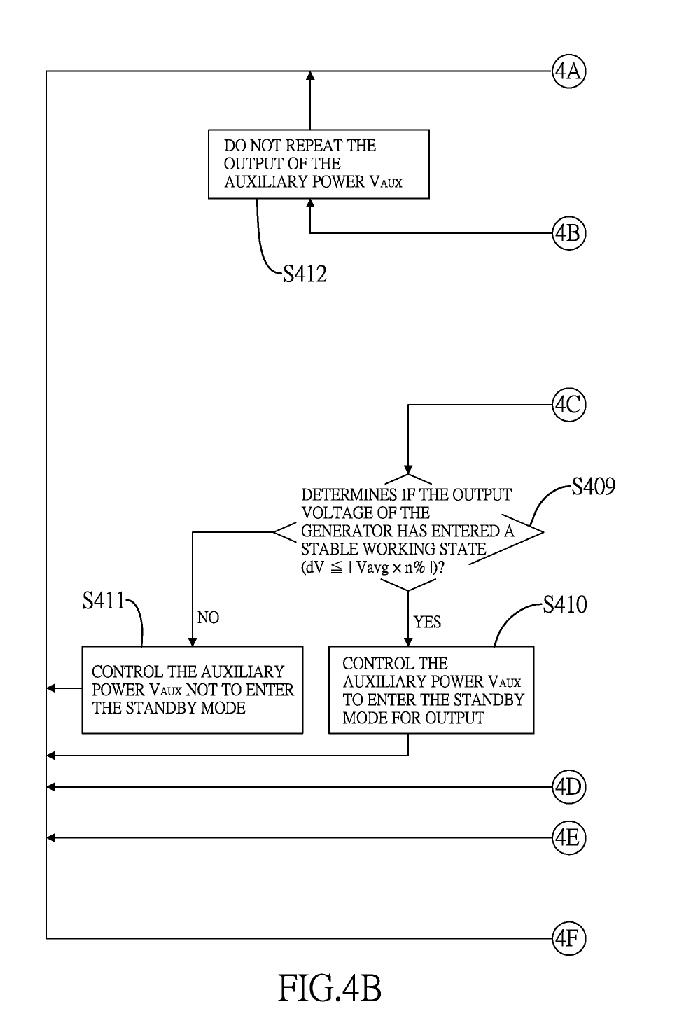

Regarding detailed operation of the auxiliary excitation device 100, with reference to FIGS. 4A to 4B, a method for controlling power excitation of the foregoing auxiliary excitation device is performed by the processor 10 and includes the following steps:

Step S401: Monitor operation status of a generator. The processor 10 constantly detects and records a voltage of output power from the generator 400 through the generator output monitoring circuit 30. When the processor 10 records, the voltage of the output power of the generator 400 is first rectified and then sampled and calculated, and the resulting information after calculation includes:

Vavg: a moving average of values of the voltage of the output power of the generator;

Vi: an instantaneous value of the voltage of the output power of the generator;

dV: a difference between Vavg and Vi; dV=Vavg−Vi; and

p: a preset voltage drop percentage.

Since in most cases the generator is maintained in a state of normal output, Vavg may reflect the rated output voltage of the generator. When there is an abnormal change in load, which results in a voltage drop in the output power of the generator, the effect on Vavg is relatively small while Vi can immediately reflect the voltage change. Hence, dV obtained by the comparison of the two voltages can be used as an important condition for monitoring operating states of the generator.

Step S402: Determine whether the generator is in operation (S402). The current step can be judged according to the frequency of the output power of the generator. When the detected frequency is below a preset value, the system determines that the generator is not in operation. Otherwise, the generator is identified to be operating. When the generator is not in operation, perform step S412.

Step 403: Determine if the auxiliary excitation device is outputting an auxiliary power V_{AUX}. When the auxiliary power V_{AUX} is outputted, perform step S413.

Step 404: Determine if the auxiliary power V_{AUX} has entered a standby mode for output (S404). When the auxiliary power V_{AUX} has not entered the standby mode for output, perform step S409.

Step 405: Determine if the voltage of the output power of the generator has experienced an instantaneous drop (such as an overloaded condition) according to an inequality dV≧Vavg×p. When negative, resume step S401.

Step 406: Output the auxiliary power V_{AUX} and start counting time.

Step 407: Determine if the time for the auxiliary excitation device to continuously output the auxiliary power has reached an overtime threshold. When the overtime threshold has not been reached, continuously output the auxiliary power V_{AUX} and resume step S401.

Step 408: Stop outputting the auxiliary power V_{AUX} (S408).

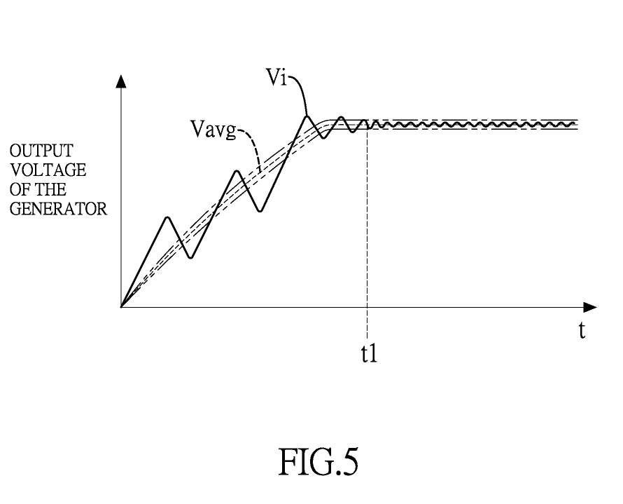

Step 409: Determines if the output voltage of the generator has entered a stable working state (S409) according to an inequality dV≦|Vavg×n %|, where n is a configured value. When the inequality is established, the output voltage of the generator is determined to enter a stable working state. Otherwise, the voltage of the output power of the generator is not stable yet. With reference to FIG. 5, before a time t1, the voltage of the output power of the generator greatly fluctuates and has not yet entered the stable working state. After the time t1, the voltage variation of the output power of the generator has been significantly reduced, the established inequality dV≦|Vavg×n %| represents that the generator has entered a stable working state. A solid line in FIG. 5 represents the instantaneous values of the voltage of the output power of the generator Vi, and a dashed line represents the moving average of the values of the voltage of the output power of the generator Vavg. In the present embodiment, n is set to 3. When the voltage of the output power of the generator has not entered a stable working state, perform step S411.

Step S410: Control the auxiliary power V_{AUX} to enter the standby mode for output.

Step S411: Control the auxiliary power V_{AUX} not to enter the standby mode.

Step S412: Do not repeat the output of the auxiliary power V_{AUX} and return to step S401 and monitor operation status of the generator. When step S402 determines that the generator is not in operation, meaning that the auxiliary power V_{AUX} fails to provide enough power for the generator to go back to a normal operation state. This type of situation usually arises from other causes that prevent the generator from reaching an operating condition. In order to avoid excessive battery power consumption, the output of auxiliary power will not be repeated.

Step S413: Activate a current-limiting function according to detection results provided by the load current measurement circuit 54, to prevent components from being burned due to an excessively large load current.

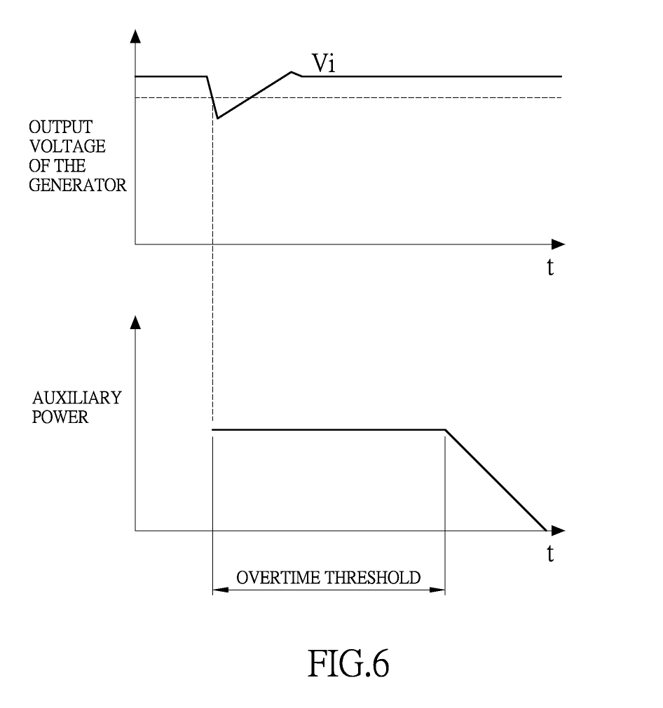

In order to further elaborate the foregoing steps S406, S407, with reference to FIG. 6, timings for auxiliary power V_{AUX} to be outputted and stopped are shown. A waveform on the top represents of the detected output voltage of generator 400, and a waveform on the bottom represents the auxiliary power V_{AUX}. When the voltage of the output power of the generator suddenly goes down by a certain amount (such as a level indicated by a dashed line in the horizontal direction), the auxiliary excitation device in accordance with the invention immediately outputs the auxiliary power V_{AUX}. When the continuous output time of the auxiliary power V_{AUX} reaches the overtime threshold, the auxiliary power V_{AUX} is gradually decreased to avoid severe fluctuation of the auxiliary power V_{AUX}, which causes the hunting behavior of excitation power outputted from the AVR 300. Thus, the voltage of the output power of the generator remains stable without jitter generation in the generator until the auxiliary power V_{AUX} stops outputting.

In the foregoing steps, the condition required to stop outputting the auxiliary power V_{AUX} depends on the overtime threshold. However, in addition to using time as the condition, in step S408, whether the output voltage of the generator has been restored to the stable working state can be used as another condition as well. If the voltage of the output power of the generator has been restored, the output of the auxiliary power V_{AUX} can be stopped in a similar fashion.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An auxiliary excitation device applied to a generator with an automatic voltage regulator (AVR) and a battery and connected between the battery and the AVR, the auxiliary excitation device comprising:
a processor having a control program built therein for determining whether to output an auxiliary power;
a battery voltage input circuit connected to the processor, receiving DC (Direct Current) power of the battery and measuring a DC voltage value of the battery, converting the DC power of the battery into an operating power for the auxiliary excitation device, and providing the measured DC voltage value of the battery to the processor;
a generator output monitoring circuit connected to the processor, monitoring voltage and frequency of output power of the generator, and providing values of the voltage and values of the frequency of the output power of the generator to the processor;
a setting circuit connected to the processor and serving to set a preset voltage drop percentage;
an auxiliary power generating circuit connected to the processor and the battery voltage input circuit, controlled by the processor to convert the DC power of the battery into the auxiliary power in the form of AC (Alternating Current) power, and outputting the auxiliary power to the AVR; and
an auxiliary power measuring circuit connected to the processor, measuring voltage of the auxiliary power, and providing a value of the voltage of the auxiliary power to the processor;
wherein the processor determines to output the auxiliary power when an inequality dV≧Vavg×p is met;
where
Vavg is a moving average of the values of the voltage of the output power of the generator;
Vi is an instantaneous value of the voltage of the output power of the generator;
dV is a difference between Vavg and Vi; and
p is the preset voltage drop percentage.

2. The auxiliary excitation device as claimed in claim 1, wherein the setting circuit serves to further set an overtime threshold, and when a time for the auxiliary power to continuously output reaches the overtime threshold, the voltage of the auxiliary power gradually drops until the output of the auxiliary power is completely stopped.

3. The auxiliary excitation device as claimed in claim 2, wherein the setting circuit has:
a voltage drop level setting circuit serving to set the preset voltage drop percentage; and
an auxiliary power output overtime setting circuit serving to set the overtime threshold.

4. The auxiliary excitation device as claimed in claim 1, wherein the battery voltage input circuit has:
a power regulation circuit converting the DC power of the battery into an operating power to supply the auxiliary excitation device; and
a battery voltage measurement circuit measuring the DC voltage value of the battery and then sending the DC voltage value of the battery to the processor.

5. The auxiliary excitation device as claimed in claim 2, wherein the battery voltage input circuit has:
a power regulation circuit converting the DC power of the battery into an operating power to supply the auxiliary excitation device; and
a battery voltage measurement circuit measuring the DC voltage value of the battery and then sending the DC voltage value of the battery to the processor.

6. The auxiliary excitation device as claimed in claim 3, wherein the battery voltage input circuit has:
a power regulation circuit converting the DC power of the battery into an operating power to supply the auxiliary excitation device; and
a battery voltage measurement circuit measuring the DC voltage value of the battery and then sending the DC voltage value of the battery to the processor.

7. The auxiliary excitation device as claimed in claim 4, wherein the auxiliary power generating circuit has:
a driving circuit connected to the processor and generating multiple driving signals according to control signals of the processor;
a full-bridge switching circuit connected to the driving circuit and the battery voltage input circuit, and converting the DC power of the battery into an AC power according to the driving signals generated by the driving circuit;
a transformer connected to an output terminal of the full-bridge switching circuit, boosting the converted AC voltage, and generating the auxiliary power;
a load current measuring circuit detecting and converting a value of current passing through the full-bridge switching circuit into a current signal, and providing the current signal to the processor; and
a reverse polarity protection circuit connected to the battery voltage input circuit, and serving to interrupt a connection between the battery and the auxiliary excitation device when the battery is reversely connected to the auxiliary excitation device.

8. The auxiliary excitation device as claimed in claim 5, wherein the auxiliary power generating circuit has:
a driving circuit connected to the processor and generating multiple driving signals according to control signals of the processor;
a full-bridge switching circuit connected to the driving circuit and the battery voltage input circuit, and converting the DC power of the battery into an AC power according to the driving signals generated by the driving circuit;
a transformer connected to an output terminal of the full-bridge switching circuit, boosting the converted AC voltage, and generating the auxiliary power;
a load current measuring circuit detecting and converting a value of current passing through the full-bridge switching circuit into a current signal, and providing the current signal to the processor; and
a reverse polarity protection circuit connected to the battery voltage input circuit, and serving to interrupt a connection between the battery and the auxiliary excitation device when the battery is reversely connected to the auxiliary excitation device.

9. The auxiliary excitation device as claimed in claim 6, wherein the auxiliary power generating circuit has:
a driving circuit connected to the processor and generating multiple driving signals according to control signals of the processor;
a full-bridge switching circuit connected to the driving circuit and the battery voltage input circuit, and converting the DC voltage of the battery into an AC voltage according to the driving signals generated by the driving circuit;
a transformer connected to an output terminal of the full-bridge switching circuit, boosting the converted AC voltage, and generating the auxiliary power;
a load current measuring circuit detecting and converting a value of current passing through the full-bridge switching circuit into a current signal, and providing the current signal to the processor; and
a reverse polarity protection circuit connected to the battery voltage input circuit, and serving to interrupt a connection between the battery and the auxiliary excitation device when the battery is reversely connected to the auxiliary excitation device.

10. The auxiliary excitation device as claimed in claim 7, wherein the processor further has:
an LED (Light-Emitting Diode) indicator circuit serving to display operation status of the auxiliary excitation device; and
a communication interface provided for the auxiliary excitation device to be adapted to connect to an external device.

11. The auxiliary excitation device as claimed in claim 8, wherein the processor further has:
an LED (Light-Emitting Diode) indicator circuit serving to display operation status of the auxiliary excitation device; and
a communication interface provided for the auxiliary excitation device to be adapted to connect to an external device.

12. The auxiliary excitation device as claimed in claim 9, wherein the processor further has:
an LED (Light-Emitting Diode) indicator circuit serving to display operation status of the auxiliary excitation device; and
a communication interface provided for the auxiliary excitation device to be adapted to connect to an external device.

13. The auxiliary excitation device as claimed in claim 10, wherein the generator output monitoring circuit has:
a voltage sensing circuit receiving and measuring the voltage of the output power of the generator and transmits the value of the voltage of the output power of the generator to the processor; and
a frequency measuring circuit measuring the frequency of the output power of the generator and transmitting the frequency of the output power of the generator to the processor.

14. The auxiliary excitation device as claimed in claim 11, wherein the generator output monitoring circuit has:
a voltage sensing circuit receiving and measuring the output voltage of the generator and transmits the measured output voltage to the processor; and
a frequency measuring circuit measuring the frequency of the output voltage of the generator and transmitting the frequency to the processor.

15. The auxiliary excitation device as claimed in claim 12, wherein the generator output monitoring circuit has:
a voltage sensing circuit receiving and measuring the voltage of the output power of the generator and transmits the measured voltage of the generator to the processor; and
a frequency measuring circuit measuring the value of the frequency of the output power of the generator and transmitting the frequency of the output power of the generator to the processor.

16. A method for controlling power excitation performed by an auxiliary excitation device, wherein the auxiliary excitation device is applied to a generator with an automatic voltage regulator (AVR) and a battery, the method comprising steps of:
monitoring operation status of a generator, wherein voltage of output power from the generator is detected and recorded to obtain a moving average of values of the voltage of the output power of the generator and an instantaneous value of the voltage of the output power of the generator;
determining if the generator is in operation;
determining if the auxiliary excitation device is outputting an auxiliary power when the generator is in operation;
determining if the auxiliary power has entered a standby mode for output when the auxiliary power is not outputted;
determining if the voltage of the output power of the generator has experienced an instantaneous drop according to an inequality dV≧Vavg×p when the auxiliary power has entered the standby mode for output; where
Vavg is the moving average of the values of the voltage of the output power of the generator;
Vi is the instantaneous value of the voltage of the output power of the generator;
dV is a difference between Vavg and Vi; and
p is a preset voltage drop percentage;
outputting the auxiliary power to the AVR when the voltage of the output power from the generator suddenly drops, wherein the auxiliary power is an AC (Alternating Current) power converted from a DC (Direct Current) power of the battery; and
determining if a condition of stopping output of the auxiliary power to the AVR have been established and, and stopping output of the auxiliary power when the condition has been established.

17. The method as claimed in claim 16, wherein the step of determining if the generator is in operation has steps of comparing a frequency of the output power of the generator with a preset frequency and determining that the generator is in operation when the frequency of the output power of the generator is higher than the preset frequency, and stopping output of the auxiliary power immediately when the generator is not in operation.

18. The method as claimed in claim 16, wherein the step of determining if the condition of stopping output of the auxiliary power to the AVR has been established has steps of determining if a time for the auxiliary excitation device to continuously output the auxiliary power has reached an overtime threshold, and gradually decreasing output of the auxiliary power until the auxiliary excitation device completely stops outputting the auxiliary power when the auxiliary power has reached the overtime threshold.

19. The method as claimed in claim 17, wherein the step of determining if the condition of stopping output of the auxiliary power to the AVR has been established has steps of determining if a time for the auxiliary excitation device to continuously output the auxiliary power has reached an overtime threshold, and gradually decreasing output of the auxiliary power until the auxiliary excitation device completely stops outputting the auxiliary power when the auxiliary power has reached the overtime threshold.

20. The method as claimed in claim 16, further comprising steps of:
when the auxiliary power has not entered the standby mode for output, determining if the voltage of the output power of the generator has entered a stable working state according to an inequality dV≦|Vavg×n %|, where n is a configured value;
when the voltage of the output power of the generator has entered the stable working state, controlling the auxiliary power to enter a standby mode; and
when the voltage of the output power of the generator has not entered the stable working state, controlling the auxiliary power not to enter the standby mode.

21. The method as claimed in claim 17, further comprising steps of:
when the auxiliary power has not entered the standby mode for output, determining if the voltage of the output power of the generator has entered a stable working state according to an inequality dV≦|Vavg×n %|, where n is a configured value;
when the voltage of the output power of the generator has entered the stable working state, controlling the auxiliary power to enter a standby mode; and
when the voltage of the output power of the generator has not entered the stable working state, controlling the auxiliary power not to enter the standby mode.
